(19) United States
(12) Patent Application Publication
(10) Pub. No.: US 2026/0284987 A1
(43) Pub. Date: Sep. 24, 2026

(54) PULTRUSION PROCESS FOR MANUFACTURING A FIBRE REINFORCED COMPOSITE ARTICLE FOR A WIND TURBINE BLADE

(71) Applicant: LM WIND POWER A/S, Kolding (DK)

(72) Inventor: Jeppe Bjørn JØRGENSEN, Kolding (DK)

(21) Appl. No.: 19/476,416

(22) PCT Filed: Apr. 24, 2024
(86) PCT No.: PCT/EP2024/061180

§ 371 Date: Oct. 17, 2025

(30) Foreign Application Priority Data
Apr. 26, 2023 (EP) 23169983.6

(51) Int. Cl. B29C 70/52; B29C 70/30; B29K 33/00; B29L 31/08; C08G 77/16; C08G 77/20

(52) U.S. Cl. CPC B29C 70/521; B29C 70/30; B29C 70/525; B29K 2033/12; B29L 2031/085; C08G 77/16; C08G 77/20

(57) ABSTRACT

The present invention relates to a pultrusion process for manufacturing a fibre reinforced composite article (64). The process comprises the steps of impregnating a fibre material, such as fibre rovings or fibre tows, with a resin to form a resin-impregnated pultrusion string (109), pulling the resin-impregnated pultrusion string through a die (107) and applying heat to the resin-impregnated pultrusion string (109) to form an at least partially cured pultrusion string. A surface (115, 116) of the at least partially cured pultrusion string is treated with a primer composition comprising a silane compound to form a primer-treated pultrusion string, and the primer-treated pultrusion string is cut to provide the pultruded composite article (64).

### FIELD OF THE INVENTION

The present invention relates to a pultrusion process for manufacturing a fibre reinforced composite article, such as a plate-shaped article, which can be used in manufacturing a wind turbine blade, in particular for manufacturing a spar cap for such blade. The present invention also relates to the pultruded composite article and to a method of manufacturing a wind turbine blade shell member using the pultruded composite article.

### BACKGROUND OF THE INVENTION

Climate change has created an urgent need for sustainable energy, putting the spotlight on wind power as a cost-effective and clean energy source. Wind turbines typically comprise a tower, generator, gearbox, nacelle, and one or more rotor blades, which capture kinetic energy of wind using known airfoil principles. With increasing energy demand, modern wind turbines can have power ratings of above 10 MW and may have rotor blades that exceed 100 meters in length.

Wind turbine blades are typically made from a fibre-reinforced polymer material and comprise a pressure side shell half and a suction side shell half. The cross-sectional profile of a typical blade includes an airfoil for creating an air flow leading to a pressure difference between both sides. The resulting lift force generates torque for producing electricity. Wind turbine blades are usually manufactured by forming two shell parts or shell halves from layers of woven fabric or fibre and resin. Spar caps or main laminates are placed or integrated in the shell halves and may be combined with shear webs or spar beams to form structural support members. Spar caps or main laminates may be joined to, or integrated within, the inside of the suction and pressure halves of the shell.

As the size of wind turbine blades increases, various challenges arise from the blades being subjected to increased forces during operation, requiring improved reinforcing structures. In some known solutions, pultruded fibrous plates of material are used to manufacture spar caps. Pultrusion is a continuous process in which fibres are pulled through a supply of liquid resin and then heated in a chamber where the resin is cured. Such pultruded plates can be cut to any desired length. As such, the pultrusion process is typically characterized by a continuous process that produces composite articles having a constant cross-section. Thus, a plurality of pultrusion plates can be vacuum infused together in a mould to form the spar caps.

Typical spar caps may comprise a plurality of pultruded composite articles and possibly one or more interlayers arranged between the carbon pultrusion elements. Such spar caps may be produced directly in the wind turbine blade moulds or in a separate offline mould where they are resin infused and then subsequently lifted into the main blade shell mould which is then infused with resin.

Different combinations of resins may be used for the spar cap and the main blade shell. It is critical to ensure a sufficiently strong adhesion between the shell and the pre-manufactured spar cap since bonding of resin onto the pre-cast main spar is crucial for the structural integrity of the blade. Vinyl ester or epoxy ester resins have good adherence properties and are often used, whereas other resins, such as polyester resin, have an attractive price. However, the adhesion properties of polyester resin are low compared to vinyl ester and epoxy resin. The use of a primer on the spar cap increase the adherence properties at the resin interface. Where the spar cap is made offline, primer may be applied to one or more surfaces of the spar cap before it is placed in the blade mould. Although a primer may enhance adhesion strength, several challenges exist in handling and process control.

Known primers are based on isocyanate chemistry and may react instantly with moisture in the air. Thus, the efficacy of the primer is reduced over time, especially at high humidity. Thus, the time from appliance of the first primer layer to the time of resin infusion is critical, and a prolonged processing time may affect the primer properties and the structural integrity of the blade.

Additionally, such known primers usually have a rather low flash point, implying high flammability and thus work hazards. Furthermore, known bonding methods that rely on the use of primers necessitate prior grinding of one or more surfaces of the premanufactured spar cap. This often leads to a dusty and noisy work environment, and associated health risks. Hence, improved methods to ensure a sufficiently strong adhesion between the shell and the premanufactured spar cap at a reduced cost would be advantageous.

Another challenge of known methods for forming spar caps from pultrusion plates is that is can be rather expensive to process the pultrusion plates. Typically, a peel ply is added to the plate during the pultrusion process, which later has to be removed again, which is both costly and creates waste. The peel ply is often included to provide improved surface activation by imprinting a structure into the covered surface.

However, after peel ply removal, the edges of the pultrusion plate often have to be ground at the top, bottom and optionally the sides. Such grinding operations remove expensive carbon material, create waste and add costs. This results in an overall rather expensive process that takes up cycle time and reduces production speed/flow. Providing respective peel ply removal stations and edge grinding stations also adds to the overall production cost and complexity.

It is therefore an object of the present invention to provide an improved method of manufacturing a blade shell member comprising a spar cap, and composite articles for use in such methods.

It is another object of the present invention to provide a method of manufacturing a blade shell member having sufficiently strong adhesion between the shell and a composite article at a reduced cost.

It is another object of the present invention to provide a method of manufacturing a blade shell member which is more efficient, relies on more cost-efficient equipment, is safer and more environmentally friendly.

### SUMMARY OF THE INVENTION

It has been found that one or more of the aforementioned objects can be obtained by a pultrusion process for manufacturing a fibre reinforced composite article, preferably a plate-shaped composite article, wherein the pultrusion process comprises the steps of impregnating a fibre material, such as fibre rovings or fibre tows, with a resin to form a resin-impregnated pultrusion string, pulling the resin-impregnated pultrusion string through a die and applying heat to the resin-impregnated pultrusion string to form an at least partially cured pultrusion string, treating a surface of the at least partially cured pultrusion string with a primer composition comprising a silane compound to form a primer-treated pultrusion string, and cutting the primer-treated pultrusion string to provide the composite article. The composite article obtained in this way can be placed into any area of a wind turbine blade where reinforcements are needed, including for example an auxiliary spar or trailing edge reinforcements.

It was found that this method eliminates the need for using peel ply as described above for known methods. The process of the present invention also renders edge grinding of the pultrusion plates unnecessary, which is required in known methods. The process of the present invention also leads to a simplified geometry of the pultrusion plates and the spar cap layup, which reduces waste and machining time and cost. Also, using the primer in this way enables later infusing the resulting pultrusion plates with a polyester resin, e.g., to form a spar cap, which additionally saves costs as compared to using vinyl ester resin and/or epoxy materials.

Thus, a composite article manufactured by said process, for example a pultruded plate for a wind turbine blade spar cap, can be optimally bonded to an inner blade shell surface by co-infusing the shell and the composite article in a blade mould for example with a polyester infusion resin to form a spar cap-reinforced wind turbine shell member. Using a primer composition comprising a silane compound to form a primer-treated pultrusion string is found to result in considerably higher bond strengths between the composite article, such as a pultrusion plate for a wind turbine blade spar cap, and the shell member of the blade. In particular, the fracture toughness at the interface between the composite article, in particular containing a vinyl ester, and a shell fibre layup infused with a polyester resin, in particular an unsaturated polyester resin, is found to be greatly improved. Also, the primer composition is found to be stable to moisture in the air, leading to a significant improvement in storage time.

The pultrusion process of the present invention preferably comprises providing a plurality of bobbins carrying respective tows of carbon fibre material, and optionally one or more bobbins carrying respective tows of carbon fibre material. Each tow can advantageously be pulled through guide plates, a resin bath, and a heated die by a pulling mechanism. The continuous pultrusion string can be cut into individual composite articles, such as individual pultrusion plates, with a length of between 30-300 meters, preferably 50-100 meters, by a cutter. The fibre material may include glass fibres, carbon fibres or a mixture of glass fibres and carbon fibres. The guide plates and/or the die may take the form of a spreader or inlet comprising multiple apertures, each aperture receiving a respective carbon fibre tow or glass fibre tow. The apertures can be spaced and they may be located so as to guide the fibre tows, for example, to form a desired pattern of glass fibre tows and carbon fibre tows in the pultrusion plates.

In a particularly preferred embodiment, the fibre reinforced composite article is a pultrusion plate. A plurality of such pultrusion plates may be placed into a wind turbine blade mould to form a spar cap of the blade. The spar cap is preferably an elongated element having an upper surface, a lower surface, a first side surface, a second side surface, a first end surface and a second end surface. Typically, a spar cap will extend over 60-95% of the blade length.

In particular, a plurality of pultrusion plates can be arranged in a stacked arrangement to form a spar cap. The plurality of pultrusion plates preferably forming the spar cap will typically extend in a spanwise direction of the shell half or of the blade. Thus, at least some of the pultrusion plates preferably have a length corresponding to 60-95% of the blade length. A polymer resin, such as a polyester resin, in particular an unsaturated polyester resin, is typically co-infused into the fibre layup and into the pultrusion plates following the arrangement of all elements in the blade mould to form a shell half with the spar cap.

The length of the composite article, such as the pultrusion plate, is typically between 50 and 150 meters, preferably between 50 and 100 meters, more preferably between 70 and 100 meters. The height/thickness of the composite article, such as the pultrusion plate, is preferably between 2 and 10 millimeters, preferably between 3 and 7 millimeters, most preferably between 4 and 6 millimeters. The width of the composite article, such as the pultrusion plate, is preferably between 20 and 300 millimeters, most preferably between 80 and 150 millimeters. In a preferred embodiment, a spar cap formed from such pultrusion plates, comprises between 1 and 15 stacks of pultrusion plates arranged next to each other, more preferably between 3 and 9 stacks. Each stack may comprise up to 20 pultrusion plates arranged on top of each other, such as 2-20 pultrusion plates or 2-10 pultrusion plates. Thus, each reinforcing section, such as each spar cap, may comprise 10 to 200 pultrusion plates.

In a preferred embodiment, the pultrusion plates of the present invention have a rectangular cross section with side lengths of 2-10 mm and 50-250 mm, most preferably side lengths of 5 mm and 100 mm.

The pultruded composite article of the present invention may have an upper surface, a lower surface, a first side surface, a second side surface, a first end surface and a second end surface. Preferably, the pultruded composite article has a cuboid shape or a box shape. In a preferred embodiment, the pultruded composite article is plate-shaped. Preferably, the pultruded composite article has a rectangular cross section.

The pultrusion process of the present invention comprises impregnating a fibre material, such as fibre rovings or fibre tows, with a resin to form a resin-impregnated pultrusion string. Usually, said fibre material will comprises continuous longitudinally aligned filaments. It is particularly preferred that said fibre material comprises carbon fibres. It is also preferred that the resin is a vinyl ester or epoxy resin. It is most preferred that the resin is a vinyl ester resin, preferably a resin produced by the esterification of an epoxy resin with acrylic or methacrylic acid.

Thus, the fibre material used in the pultrusion process preferably comprises a plurality of tows or rovings of carbon fibre material, and optionally one or more tows or rovings of glass fibre material. Thus, each composite article, such as a pultrusion plate, may comprise 20-200 tows of fibre material in total. The tows will usually extend in the length direction of the pultrusion plate, i.e. substantially parallel to its longitudinal axis, or parallel to the spanwise direction when arranged in the blade shell. In a preferred embodiment, the tows of fibre material are arranged in a regular array or regular grid of rows and columns of tows, as seen in a vertical cross section of the pultrusion plate. Each pultrusion plate preferably comprises at least 10 rows and at least 10 columns of tows.

The resin-impregnated pultrusion string is pulled through a die and heat is applied to the resin-impregnated pultrusion string to form an at least partially cured pultrusion string, such as a fully cured pultrusion string. The heat can be applied during passing through the die or after passing through the die, e.g. in a separate heating station. In a preferred embodiment, the step of applying heat to the resin-impregnated pultrusion string to form an at least partially cured pultrusion string comprises heating the pultrusion string to temperatures of 160-200° C. degrees, for example for 1-5 minutes. In a preferred embodiment, the die is a heated die. Thus, the step of applying heat to the resin-impregnated pultrusion string can be advantageously carried out while pulling the resin-impregnated pultrusion string through the die.

A surface of the at least partially cured pultrusion string is treated with a primer composition comprising a silane compound to form a primer-treated pultrusion string. In a preferred embodiment, the primer is applied to the surface of the pultrusion string after the pultrusion string exits the die. This step can advantageously be carried out using a brush, such as a foam brush, or by using a roller device. In other embodiments, the primer composition can be applied using a spray gun.

It is particularly preferred that at least a lower surface or bottom surface and an upper surface or top surface of the pultrusion string is treated with the primer composition of the present invention. In some embodiments, also other surfaces of the pultrusion string are treated with the primer composition, such as the side surfaces of the pultrusion string.

Thus, in a preferred embodiment, the pultrusion string has a top surface and an opposing bottom surface. In some embodiments, the primer composition is applied at least to the bottom surface of the pultrusion string. In some embodiments, the primer composition is applied to the bottom surface and to the top surface of the pultrusion string. In some embodiments, the primer composition is applied to all surfaces of the pultrusion string.

According to a preferred embodiment a primer application station is provided downstream the die to treat a surface of the at least partially cured pultrusion string with the primer composition comprising a silane compound. Also, preferably a heat activation station is provided downstream the primer application station for heating the primer-treated pultrusion string, preferably comprising an infrared heating device.

It is particularly preferred that the process further comprises applying heat to the primer-treated pultrusion string to provide an activated surface on the pultrusion string, preferably wherein the heating temperature is 80-150° C., most preferably 90-120° C. In other embodiments, the heat activation can be carried out after the pultrusion process, i.e., by heating the composite article.

It is thus preferred that heat is applied to the primer-treated surface of the pultrusion string or of the composite article to provide an activated surface. In a preferred embodiment, the primer-treated pultrusion string, or the pultruded composite article, is heated to a temperature of 80-200° C., preferably 80-130° C., most preferably 90-120° C. Preferably, covalent bonds are formed in said heat activation step between the silane compound of the primer composition and the resin, preferably vinyl ester resin, used for impregnation in the pultrusion process. In a preferred embodiment, the step of applying heat to the primer-treated surface comprises heating said primer-treated surface to a temperature of 80-130° C., preferably 90-120° C., for a time period of 1-60 minutes, preferably 5-30 minutes. The heating step is preferably carried out using an infrared heating device. Using such device, it was found that the primer treated surface can achieve the desired heating temperature, for example >120° C., in less than 30 seconds, leading to a particularly efficient process.

It is preferred that the resin is a vinyl ester resin. It was found that using a vinyl ester resin leads to a fibre reinforced composite article with improved mechanical properties and increased chemical resistance. Vinyl ester resins can, for example, be formulated from styrene and a condensation product of methacrylic acid with an epoxy. It was also found that a surprisingly faster line speed can be achieved when the resin is a vinyl ester resin due to an improved impregnation process. Furthermore, it is found that the step of treating the surface of the at least partially cured pultrusion string with a primer composition comprising a silane compound to form a primer-treated pultrusion string can be carried out particularly efficiently when using a vinyl ester resin to form a resin-impregnated pultrusion string.

In some embodiments, the heating step to activate the primer-treated surface is also used to allow the partially cured pultrusion string to fully cure. Thus, the pultrusion process of the present invention may comprise a first heating step to at least partially cure the resin-impregnated pultrusion string prior to primer treatment, and a second heating step following the primer treatment to activate the primer-treated surface and optionally to complete the resin curing.

The surface of the pultrusion string may be treated with the primer composition such that said surface is impregnated with the primer composition. In a preferred embodiment, the primer composition is applied to the surface of the pultrusion string in an amount of 20-50 g/m2, preferably in an amount of 30-35 g/m2.

Prior to the step of applying heat to the primer-treated surface of the pultrusion string the process of the present invention may comprise a step of drying the primer-treated surface(s) of the pultrusion string. Said drying step may be carried out at a temperature of 20-40° C. for a time period of 10-150 minutes.

In a preferred embodiment, the step of applying heat to the primer-treated pultrusion string to provide an activated surface comprises forming a chemical bond between the silane compound of the primer composition and hydroxy groups of the resin-impregnated pultrusion string, preferably hydroxy groups of a vinyl ester resin of the resin-impregnated pultrusion string.

The step of cutting the primer-treated pultrusion string to provide the composite article preferably comprises cutting the primer-treated pultrusion string into individual composite articles, such as pultrusion plates, having a length of between 30-200 meters, preferably 50-100 meters.

In a preferred embodiment, the silane compound of the primer composition comprises a hydroxysilylalkyl methacrylate or a (poly) condensation product of a hydroxysilylalkyl methacrylate. In a preferred embodiment, the silane compound is a polymer comprising a repeating unit of formula (I):

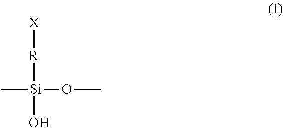

wherein X is an organic group, preferably a non-hydrolyzable organic group, preferably selected from amino, vinyl, epoxy, (meth)acrylate, sulfur, alkyl, alkenyl, alkynyl, most preferably methacrylate, and wherein R is a spacer such as —(CH₂)ₙ—, wherein n is 0 to 1000, preferably 1-5, most preferably 3.

In a preferred embodiment, the silane compound is polymerizable to a polymer comprising a repeating unit of formula (I):

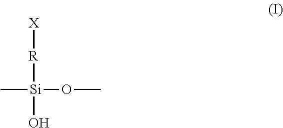

wherein X is an organic group, preferably a non-hydrolyzable organic group, preferably selected from amino, vinyl, epoxy, methacrylate, sulfur, alkyl, alkenyl, alkynyl, most preferably methacrylate, and wherein R is a spacer such as —(CH₂)ₙ—, wherein n is 0 to 1000, preferably 1-5, most preferably 3.

In a preferred embodiment, the silane compound is derived from hydrolysation and subsequent (poly) condensation of X—R¹—Si(OR²)₃ monomers, wherein X is a non-hydrolyzable organic group, such as amino, vinyl, epoxy, methacrylate, sulfur, alkyl, alkenyl, alkynyl, preferably methacrylate; R¹ is a spacer such as —(CH₂)ₙ—, wherein n is 0 to 1000, preferably 1-5, most preferably 3; R² is independently selected from hydrogen, optionally substituted alkyl, optionally substituted alkenyl, optionally substituted alkynyl, optionally substituted carbocyclyl, optionally substituted aryl, optionally substituted 5-10 membered heteroaryl, and optionally substituted 5-10 membered heterocyclyl, preferably alkoxy, most preferably methoxy.

The primer composition of the present invention is preferably a liquid composition, preferably comprising an organic solvent. Preferably, the silane compound of the primer composition is an organic silane compound. The primer composition of the present invention may contain, or may be derived from, one or more reactive silanes containing both organofunctional and hydrolyzable groups. Advantageously, such silane compounds participate in the cross-linking reactions, but also establishes bonds between the silicone network and the substrate. The silane compound of the present invention is preferably derived from hydrolyzation of a silane of the general structure RSiX3, where R is, or comprises, a reactive organofunctional group and X is, or comprises, a hydrolyzable group, such as a methoxy, ethoxy or acetoxy group. Preferably, the silane compound of the primer composition comprises silanol groups. Such silanol groups advantageously allow condensation reactions to occur, which result in the formation of Si—O—Si bonds between the silane monomers. Advantageously, the organofunctional group of the silane compound reacts with chemical reactive groups present in the resin used for infusing the blade moulding cavity, preferably a polyester resin, most preferably an unsaturated polyester resin. The organofunctional group may be selected from aminoalkyl, mercaptoalkyl, epoxyalkyl, ureidoalkyl, acrylate and isocyanurate groups.

In a preferred embodiment, the silane compound of the present invention comprises a (meth)acrylate group, preferably a (meth)acrylate end group. In a preferred embodiment, the silane compound comprises a methacryloxy moiety, such as a (methacryloxy)alkyl moiety, such as (methacryloxy) propyl. In a preferred embodiment, the silane compound is a methacrylate-functional silane.

Preferably, the silane compound is, or comprises, or is polymerized from, a hydroxysilylalkyl methacrylate. In a particularly preferred embodiment, the silane compound comprises, or is polymerized from, 3-(trihydroxysilyl) propyl methacrylate. In a preferred embodiment, the silane compound is an oligomeric or a polymeric silane compound, preferably a polymeric organo alkoxysilane compound. In a particularly preferred embodiment, the silane compound is a polymeric organo alkoxysilane compound comprising (meth)acrylate groups, preferably methacrylate groups.

In a preferred embodiment, the silane compound is capable of forming a polymeric silane compound, preferably a polymeric organo alkoxysilane compound. In a particularly preferred embodiment, the silane compound is capable of forming a polymeric organo alkoxysilane compound comprising (meth)acrylate groups, preferably methacrylate groups.

In a particularly preferred embodiment, the silane compound of the primer composition is obtainable by hydrolysis of a trialkoxysilylpropyl methacrylate, preferably 3-(trimethoxysilyl) propyl methacrylate. It is particularly preferred that the silane compound of the present invention is an oligomer or a polymer obtained from the polymerization of 3-(trimethoxysilyl) propyl methacrylate monomers. Thus, it is preferred that the silane compound of the primer composition comprises polymerized 3-(trimethoxysilyl) propyl methacrylate.

In a preferred embodiment, the silane compound is obtained by hydrolysis of an alkoxysilane monomer or of an organo alkoxysilane monomer, preferably by hydrolysis of an organo alkoxysilane with a trimethoxysilane moiety and a methacrylate moiety, optionally followed by a condensation reaction between the hydrolysed silane compounds, preferably a polycondensation via silanol groups, to form siloxane bridges (Si—O—Si). In some embodiments, when applied to a surface, such as to a surface of a pultrusion string, preferably a pultrusion string containing a vinyl ester resin, it is preferred that a condensation reaction occurs between the hydrolysed silane compounds, preferably a polycondensation via silanol groups, to form siloxane bridges (Si—O—Si).

It is thus preferred that the silane compound is a polymeric silane compound obtained via silanol condensation to form siloxane bonds, or that the silane compound is polymerizable to form a polymeric silane compound obtained via silanol condensation to form siloxane bonds.

In a preferred embodiment, the silane compound, or a precursor thereof, comprises a methacryloxy functionality and a methoxy silane functionality. The methacryloxy functionality can be advantageously used in a free radical cure with a suitable resin, such as unsaturated polyester resins, which can be advantageously used for infusing the blade moulding cavity. This advantageously leads to strong bonds between a blade shell fibre material and the primer-treated composite article, such as a pultrusion plate. It is thus particularly preferred that the silane compound is obtained by hydrolysis of γ-methacryloxypropyltrimethoxysilane and subsequent condensation, preferably polycondensation, via the respective silanol groups of the monomers.

In a preferred embodiment, the resin used in the pultrusion process is a vinyl ester resin. Also, in a preferred embodiment, the fibre material comprises carbon fibres. In a preferred embodiment, the step of impregnating the fibre material with a resin, such as vinyl ester resin, comprises passing the fibre material through an impregnation device such as a resin bath or an impregnation chamber.

It is preferred that the pultrusion process of the present invention also comprises a surface contouring step, for example, following, or simultaneously with, the primer treatment. Thus, preferably, the pultrusion process comprises providing the pultrusion string with a three-dimensional surface structure, e.g., by an imprinting or an embossing operation. In a preferred embodiment, the process further comprises a step of imprinting a three-dimensional structure onto a surface of the primer-treated pultrusion string. It is particularly preferred that said surface contouring or imprinting is applied to an upper surface and to a lower surface of the pultrusion string. Typically, said surface contouring or imprinting will be carried out in a direction substantially perpendicular to the pultrusion direction.

In a preferred embodiment, the step of imprinting a three-dimensional structure comprises impinging a plurality of particles, preferably metal particles, onto the surface of the primer-treated pultrusion string, preferably by shot peening. In some embodiments, the three-dimensional structure comprises a plurality of cavities having a depth of at least 1 mm as compared to the surrounding surface.

In a preferred embodiment, the step of treating the surface of the at least partially cured pultrusion string with a primer composition is carried out using at least one roller having a three-dimensional pattern, such as a plurality of dots on its surface, for transferring said pattern onto a surface of the pultrusion string. In some embodiments, the pattern is an undulated pattern. In a preferred embodiment, the pattern comprises a plurality of dots.

In another aspect, the present invention relates to a fibre reinforced composite article, such as a plated-shaped composite article, such as a pultrusion plate, obtainable by the pultrusion process of the present invention. It is preferred that said composite article comprises a carbon fibre material and a vinyl ester resin. In a preferred embodiment, the layer thickness of the primer composition on one or more surfaces of the composite article is 10-50 μm.

In a particularly preferred embodiment, the surface of the composite article comprises a contour or a three-dimensional pattern, preferably a dotted pattern.

In another aspect, the present invention relates to a method of manufacturing a wind turbine blade shell member, such as a shell half, the method comprising the steps of providing a blade mould for the blade shell member, the blade mould comprising a moulding cavity, arranging one or more layers of fibre material in the moulding cavity to provide a fibre layup, placing a plurality of fibre reinforced composite articles, preferably pultrusion plates, obtained by the pultrusion process of the present invention into the moulding cavity on top of at least part of the fibre layup, infusing the moulding cavity with resin, and curing the resin to form the blade shell member.

It is particularly preferred that the plurality of fibre reinforced composite articles form a spar cap of the wind turbine blade shell member. The step of placing a plurality of fibre reinforced composite articles, which may take the form of pultrusion plates, into the moulding cavity on the fibre layup preferably comprises arranging the pultrusion plates into adjacent stacks of pultrusion plates, wherein adjacent refers to a substantially chordwise direction. These stacks usually extend in a substantially spanwise direction of the shell half.

When infusing the moulding cavity with resin, the composite articles, such as the pultrusion plates, are advantageously bonded with the blade shell material to form the blade shell member. The resin infusion step usually comprises co-infusing the composite articles, such as the pultrusion plates, and the blade shell material with a resin, preferably a polyester resin, such as an unsaturated polyester resin, for example in a VARTM process.

The method of the present invention is for providing a blade shell member, such as a suction side shell member or a pressure side shell member. It is to be understood that the same method may be used for providing a suction side shell member as well as a pressure side shell member. The only difference between providing the pressure side shell member and the suction side shell member would be the shape of the blade mould.

The wind turbine blade is usually manufactured from two shell members or shell halves, a pressure side shell half and a suction side shell half. Such shell members are typically formed in separate open blade moulds conforming to the aerodynamic shapes of the shell halves, which are subsequently joined together by closing the blade moulds to form a wind turbine blade. Thus, the wind turbine blade shell member manufactured by the method of the present invention typically is a shell half, such as a shell half with a reinforcing structure such as a spar cap. The blade shell material may include one or more fibre layers and/or a gelcoat. In a preferred embodiment, the pressure side shell half and the suction side shell half each have a longitudinal extent L of 50-120 m, preferably 60-110 m.

One or more layers of fibre material, preferably a plurality of layers of fibre material comprising glass fibres such as glass fibre fabrics, are arranged in the moulding cavity to provide a fibre layup, typically comprising an outer surface facing towards the moulding surface and conforming to an aerodynamic outer shape of the blade half, and an inner surface onto which the composite articles, such as the pultrusion plates, are placed, preferably to form a spar cap-reinforced shell member.

The pultruded composite articles, and optionally a number of interlayers comprising fibre material for promoting resin flow between the pultruded composite articles, are advantageously arranged in a stacked array, optionally wherein the plurality of pultruded composite articles are separated by respective interlayers.

The pultruded composite article of the present invention, such as the pultrusion plate, is preferably an elongated element with a rectangular cross-section and made from a fibre material comprising carbon fibres and a resin, preferably a vinyl ester resin. Alternatively, the pultruded composite articles of the present invention may comprise a mixture of carbon fibres and glass fibres. The optional interlayers may comprise fibre material, such as glass fibres or polymeric material for promoting resin flow between the pultruded planks.

The pultruded composite article of the present invention may have an upper surface, a lower surface, a first side surface, a second side surface, a first end surface and a second end surface. Typically, a plurality of pultruded composite articles are arranged in the moulding cavity such that their lower surface contacts the fibre layup of the shell. In some embodiments, the upper surface and lower surface of the pultruded composite article are preferably arranged opposite each other and may have substantially the same size. In the same way, the first and second side surfaces of the pultruded composite article may be arranged opposite each other and have substantially the same sizes, and the first and second end surfaces may be arranged opposite each other and preferably have substantially the same sizes.

In some embodiments, the fibre lay-up comprises a predetermined mounting region for placement of the pultruded composite articles. In some embodiments, also the predetermined mounting region on the fibre lay-up is treated with the primer composition. In some embodiments, the predetermined mounting region for placement of the pultruded composite articles may comprise a recess formed in the inner surface of the shell material, i.e. the upward facing surface of the fibre lay-up in the moulding cavity.

The step of placing the pultruded articles into the moulding cavity on top of at least part of the fibre layup preferably comprises placing the pultruded articles on a predetermined spar cap mounting region on the fibre layup, i.e. on the inner surface or upwardly facing surface of the fibre layup in the blade mould. At least part of said activated surface of the pultruded articles, preferably the lower surface or bottom surface of the article, is placed in contact with the fibre layup. The bonding advantageously occurs at the interface between the fibre layup and the primer-treated surface of the pultruded article.

Thus, in the steps of infusing the moulding cavity with resin and curing the resin to form the blade shell member, the fibre lay-up and the pultruded composite articles with the activated surface(s) are preferably co-infused with a resin such as epoxy, polyester or vinyl ester. A particularly preferred resin for this step is a polyester resin, preferably an unsaturated polyester resin.

In a preferred embodiment, the step of infusing the moulding cavity with resin comprises infusing the moulding cavity with a polyester resin, preferably an unsaturated polyester resin. In a preferred embodiment, the step of infusing the moulding cavity with resin is carried out by vacuum-assisted resin transfer moulding. In a preferred embodiment, the pultruded composite articles comprise a vinyl ester resin.

In a preferred embodiment, the resin is an unsaturated polyester resin, and wherein the step of curing the resin to form the blade shell member comprises a free-radical crosslinking reaction between the silane compound, or a polymer thereof, and the unsaturated polyester resin, preferably between the (meth)acrylate groups of the silane compound of the primer composition, or a polymer thereof, and the unsaturated polyester resin.

In a preferred embodiment, the primer composition comprises a carrier solvent, wherein the carrier solvent comprises 1-methoxy-2-propanol and an ester of a dicarboxylic acid, such as dimethyl glutarate, dimethyl succinate and dimethyl adipate or mixtures thereof, such as a mixture containing 57-67 wt % dimethyl glutarate, 18-28 wt % dimethyl succinate, and 8-22 wt % dimethyl adipate. In a preferred embodiment, the weight ratio of 1-methoxy-2-propanol to the ester of a dicarboxylic acid is between 1:2 to 2:1, preferably from 1:1.2 to 1.2:1. Such mixture are found to be both silane compatible and sufficiently non-flammable. Thus, in a preferred embodiment, the primer composition has a flash point of at least 39° C.

According to some embodiments, the method of the present invention further comprises a step of arranging one or more shear webs in at least one of the shell members such as one of the shell halves, usually at the location of the pultruded composite articles. Each shear web may comprise a web body, a first web foot flange at a first end of the web body, and a second web foot flange at a second end of the web body. In some embodiments, the shear webs are substantially I-shaped. Alternatively, the shear webs may be substantially C-shaped.

In another aspect, the present invention relates to a wind turbine blade shell member obtainable by the method of the present invention. It was surprisingly found that a spar-cap reinforced wind turbine blade shell member, such as shell half, is characterized by a greatly improved bonding strength and fracture toughness, as compared to shell members obtained by known processes. The present invention also relates to a wind turbine blade having a pressure side shell half and a suction side shell half, wherein the suction and pressure side shell halves are joined along a leading and trailing edge of the blade. One or both of the suction and pressure side shell halves may be obtained by the method of the present invention.

In another aspect, the present invention relates to a use of a silane-containing primer composition to improve the bonding between a first wind turbine blade component and a second wind turbine blade component, by treating a surface of the first wind turbine blade component and/or of the second wind turbine blade component with the primer composition prior to joining and co-infusing the first wind turbine blade component to the second wind turbine blade component with a resin, preferably a polyester resin, most preferably an unsaturated polyester resin. Preferably, the blade components are joined along the primer-treated surface(s).

The primer composition of said use is preferably a liquid composition, preferably comprising an organic solvent. Preferably, the silane compound of the primer composition is an organic silane compound, as described in detail above.

The first wind turbine blade component is preferably a fibre-reinforced shell part, such as a shell half comprising a predetermined spar cap mounting region, and the second wind turbine blade component is preferably a spar cap or a main laminate. It is preferred that the second component comprises a vinyl ester resin and/or has been manufactured by infusing a fibre material, preferably comprising carbon fibres, with a vinyl ester resin.

Said use preferably further comprises applying heat to the primer-treated first wind turbine blade component and/or to the primer-treated second wind turbine blade component to provide an activated surface prior to joining and co-infusing the first wind turbine blade component to the second wind turbine blade component with a resin.

In another aspect, the present invention relates to a pultrusion process which comprises applying a primer impregnated peel ply onto a resin-impregnated pultrusion string, which preferably comprises carbon fibres and a vinyl ester resin, wherein the primer composition comprises a silane compound.

All features and embodiments discussed above with respect to the pultrusion process likewise apply to the pultruded composite article and to the method of manufacturing a wind turbine blade shell member and vice versa.

As used herein, the term “silane” refers to a compound containing a silicon atom in the backbone. The term “silane” may refer to an organic compound containing one or more silicon atoms. The term “silane” may thus refer to any silicon analog of a substituted or unsubstituted hydrocarbon. As used herein, the term “silane” can comprise mixtures of different silane compounds.

As used herein, the term “methacrylate-functional silane” refers to silanes comprising methacrylate functional groups. Methacrylates are derivatives of methacrylic acid.

As used herein, the term “spanwise” is used to describe the orientation of a measurement or element along the blade from its root end to its tip end. In some embodiments, spanwise is the direction along the longitudinal axis and longitudinal extent of the wind turbine blade.

### DETAILED DESCRIPTION OF THE INVENTION

The invention is explained in detail below with reference to an embodiment shown in the drawings, in which

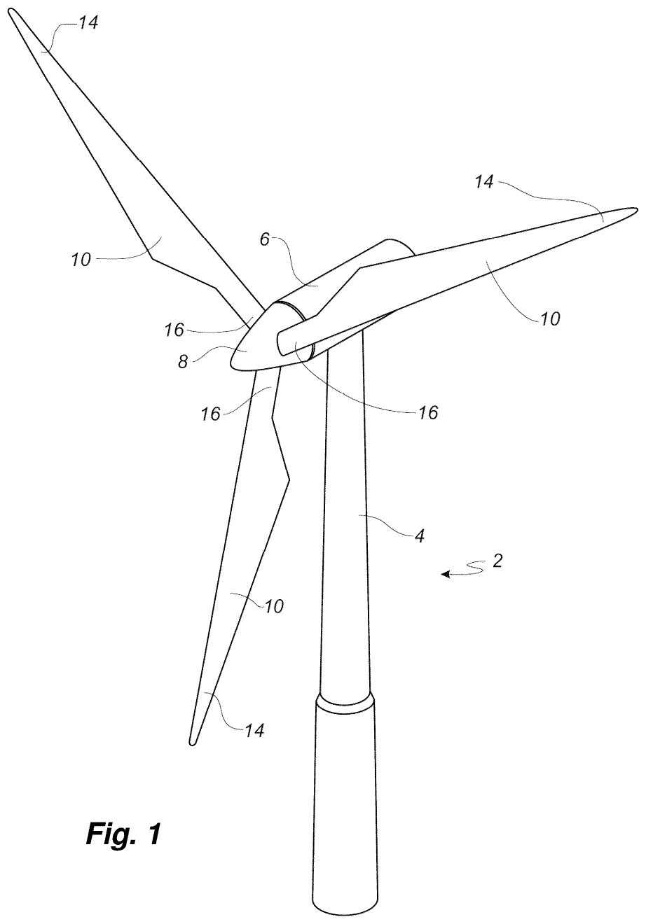

FIG. 1 shows a wind turbine,

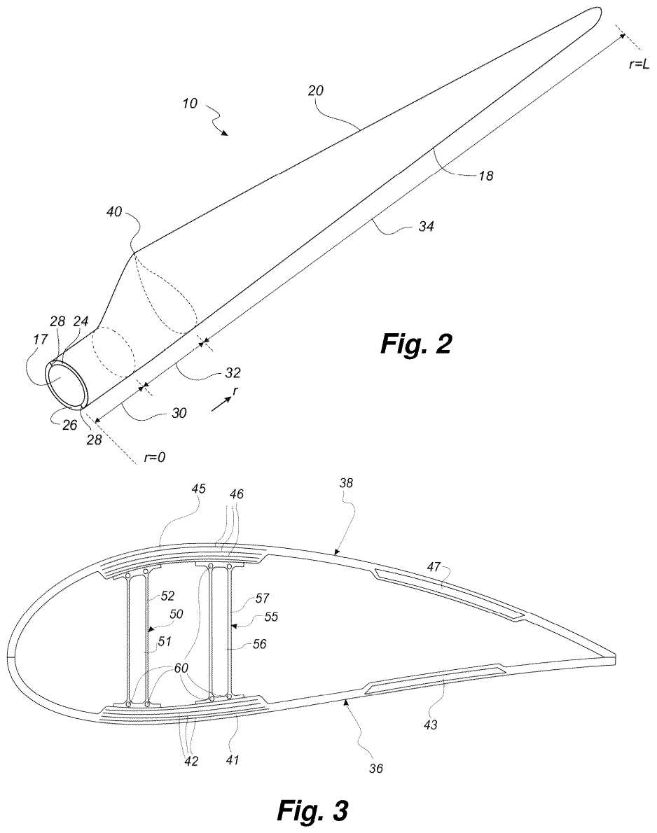

FIG. 2 shows a schematic view of a wind turbine blade,

FIG. 3 shows a schematic view of a cross-section of a wind turbine blade,

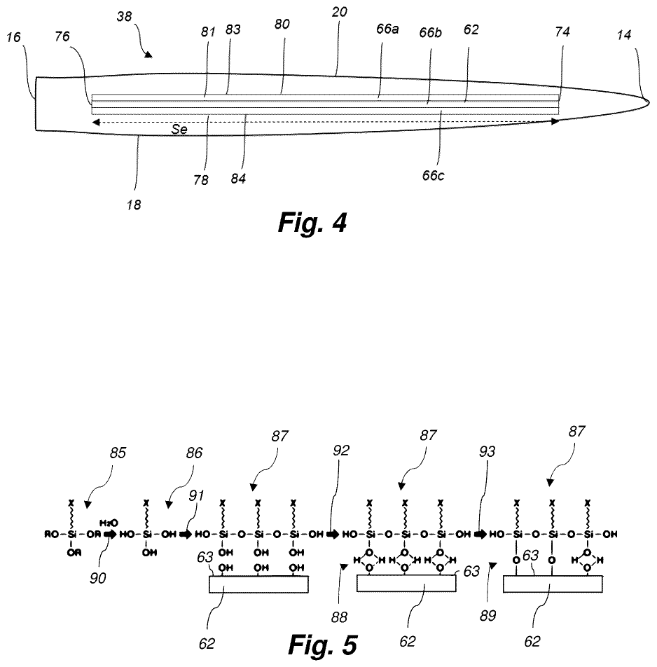

FIG. 4 is a schematic top view of a shell half of a wind turbine blade according to the present invention,

FIG. 5 is a schematic view illustrating various stages of preparing and using a silane-based primer of the present invention,

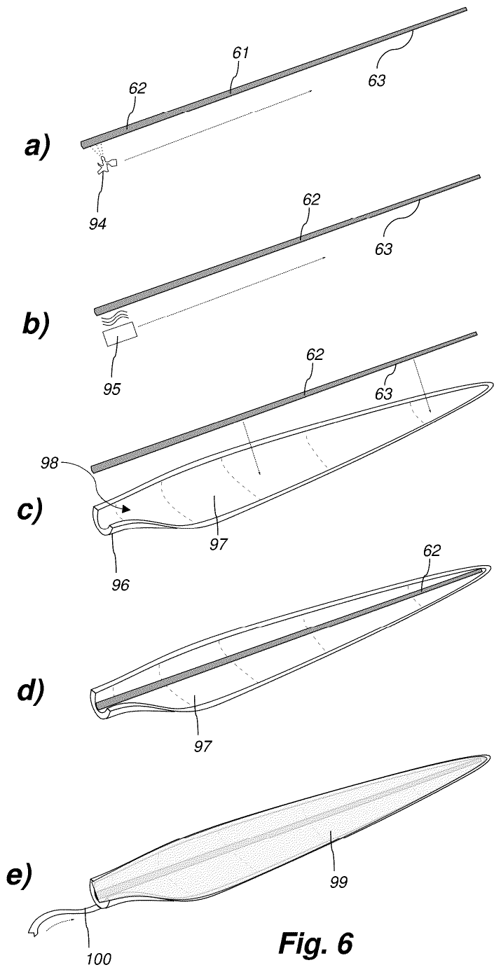

FIG. 6 illustrates various steps of a method of manufacturing a blade shell member,

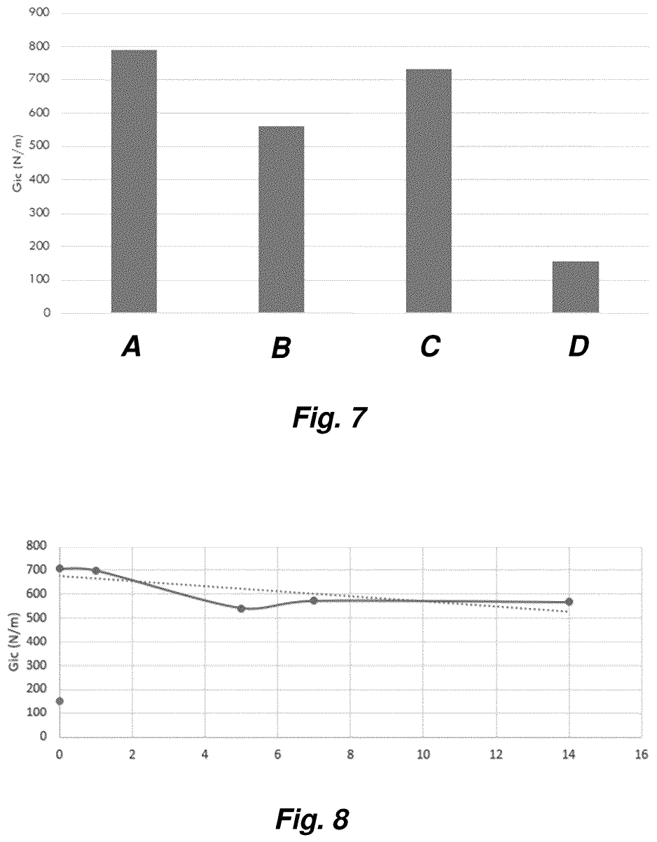

FIG. 7 is a chart of measured bonding strengths between wind turbine blade components,

FIG. 8 is a chart of bonding strength between two wind turbine blade components over time,

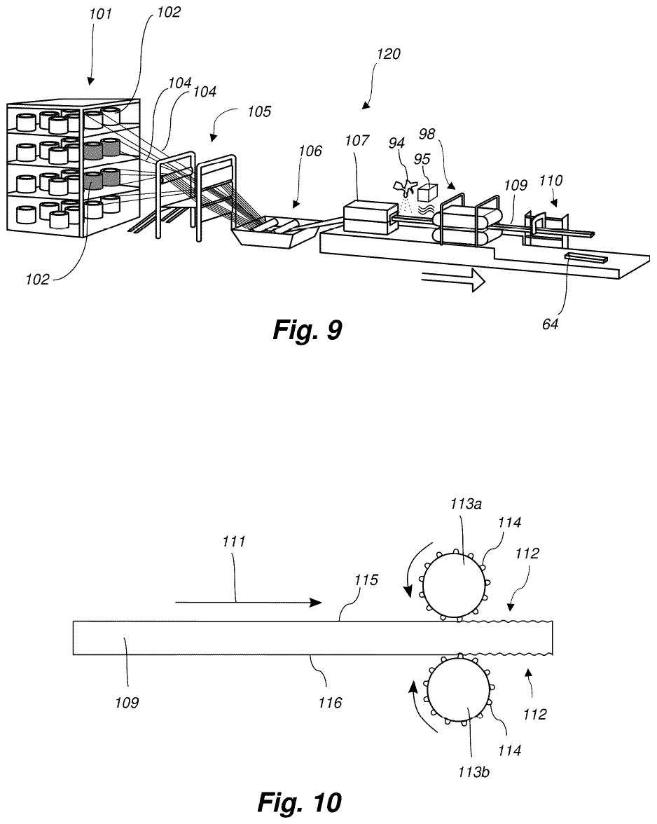

FIG. 9 is a schematic illustration of a pultrusion process for manufacturing a fibre reinforced composite article according to the present invention,

FIG. 10 is a simplified side view illustration of a process of imprinting a three-dimensional structure onto a surface of the primer-treated pultrusion string according to one embodiment of the present invention, and

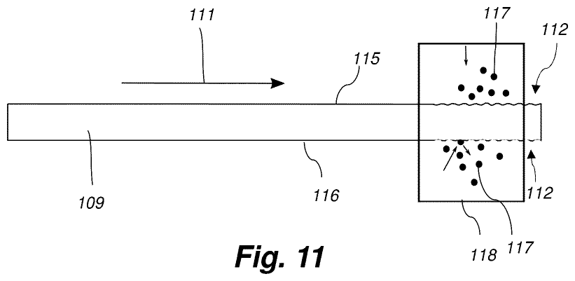

FIG. 11 is a simplified side view illustration of a process of imprinting a three-dimensional structure onto a surface of the primer-treated pultrusion string according to another embodiment of the present invention.

### DETAILED DESCRIPTION OF THE FIGURES

FIG. 1 illustrates a conventional modern upwind wind turbine according to the so-called “Danish concept” with a tower 4, a nacelle 6 and a rotor with a substantially horizontal rotor shaft. The rotor includes a hub 8 and three blades 10 extending radially from the hub 8, each having a blade root 16 nearest the hub and a blade tip 14 farthest from the hub 8. The rotor has a radius denoted R.

FIG. 2 shows a schematic view of a wind turbine blade 10. The wind turbine blade 10 has the shape of a conventional wind turbine blade and comprises a root region 30 closest to the hub, a profiled or an airfoil region 34 farthest away from the hub and a transition region 32 between the root region 30 and the airfoil region 34. The blade 10 comprises a leading edge 18 facing the direction of rotation of the blade 10, when the blade is mounted on the hub, and a trailing edge 20 facing the opposite direction of the leading edge 18.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub. The diameter (or the chord) of the root region 30 may be constant along the entire root area 30. The transition region 32 has a transitional profile gradually changing from the circular or elliptical shape of the root region 30 to the airfoil profile of the airfoil region 34. The chord length of the transition region 32 typically increases with increasing distance r from the hub. The airfoil region 34 has an airfoil profile with a chord extending between the leading edge 18 and the trailing edge 20 of the blade 10. The width of the chord decreases with increasing distance r from the hub.

A shoulder 40 of the blade 10 is defined as the position, where the blade 10 has its largest chord length. The shoulder 40 is typically provided at the boundary between the transition region 32 and the airfoil region 34. FIG. 2 also illustrates the longitudinal extent L, length or longitudinal axis of the blade.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub. The blade is typically made from a pressure side shell part 36 and a suction side shell part 38 that are glued to each other along bond lines at the leading edge 18 and the trailing edge of the blade 20.

FIG. 3 shows a schematic view of a cross section of the blade. As previously mentioned, the blade 10 comprises a pressure side shell part 36 and a suction side shell part 38.

The pressure side shell part 36 comprises a spar cap 41, also called a main laminate, which constitutes a load bearing part of the pressure side shell part 36. The spar cap 41 comprises a plurality of fibre layers 42 mainly comprising unidirectional fibres aligned along the longitudinal direction of the blade in order to provide stiffness to the blade. The suction side shell part 38 also comprises a spar cap 45 comprising a plurality of fibre layers 46. The pressure side shell part 36 may also comprise a sandwich core material 43 typically made of balsawood or foamed polymer and sandwiched between a number of fibre-reinforced skin layers. The sandwich core material 43 is used to provide stiffness to the shell in order to ensure that the shell substantially maintains its aerodynamic profile during rotation of the blade. Similarly, the suction side shell part 38 may also comprise a sandwich core material 47.

The spar cap 41 of the pressure side shell part 36 and the spar cap 45 of the suction side shell part 38 are connected via a first shear web 50 and a second shear web 55. The shear webs 50, 55 are in the shown embodiment shaped as substantially I-shaped webs. The first shear web 50 comprises a shear web body and two web foot flanges. The shear web body comprises a sandwich core material 51, such as balsawood or foamed polymer, covered by a number of skin layers 52 made of a number of fibre layers. The blade shells 36, 38 may comprise further fibre-reinforcement at the leading edge and the trailing edge. Typically, the shell parts 36, 38 are bonded to each other via glue flanges.

FIG. 4 is a schematic top view of a shell half 38 of a wind turbine blade according to the present invention, illustrating the location of a reinforcing structure 62, such as a spar cap, having a spanwise extent Se. In the illustrated embodiment, the reinforcing structure 62 comprises three adjacent stacks 66a, 66b, 66c of pultrusion plates. As seen in FIG. 4, the elongate reinforcing structure 62 extends in a substantially spanwise direction of the blade, with adjacent stacks 66a, 66b, 66c of pultrusion plates. The elongate reinforcing structure 62 has a tip end 74, closest to the tip end of the blade, and a root end 76, closest to the root end of the blade. The elongate reinforcing structure also comprises a spanwise extending front edge 78, which is closest to the leading edge 18 of the blade, and a spanwise extending rear edge 80, which is closest to the trailing edge 20 of the blade.

FIG. 5 is a schematic view illustrating various stages of preparing and using a silane-based primer of the present invention on a surface 63 of a pre-fabricated spar cap member 62 or on a surface of a pultrusion string. First, an organo alkoxysilane monomer 85 is hydrolyzed, see step 90. The moiety X preferably comprises a methacrylate moiety. Preferably, RO/OR is an alcohol moiety. The hydrolyzed monomers are then polymerized, step 91, in a condensation reaction to form a polymer 87 with siloxane bridges (Si—O—Si). The surface 63 of the spar cap member 62 is then treated with this primer composition comprising the polymer 87, step 92. Preferably, the spar cap member 62 comprises a vinyl ester resin, such that hydroxy (OH) groups of the vinyl ester resin in the surface 63 of the spar cap member 62 can form hydrogen bonds 88 with the spar cap member surface 63. Upon heating the primer-treated surface, step 93, covalent bonds 89 are formed between the polymeric organo alkoxysilane 87 and the vinyl ester of the spar cap member, leading to a strong bonding of the primer composition to the spar cap member surface.

FIG. 6 illustrates various steps of a method of manufacturing a blade shell member. A pre-manufactured spar cap member 62 can be provided having a top surface 61 and an opposing bottom surface 63, wherein the bottom surface is to be brought into contact and bonded to a fibre layup of the shell member, such as a shell half. First, the lower surface 63 of the spar cap member 62 is treated with the primer composition, preferably a liquid primer composition, for example by using a spray gun 94 which can be moved along the arrow illustrated in FIG. 6a. However, other techniques can be used, such as application by a brush, or various other application techniques.

Next, heat is applied to the primer-treated surface 63 to provide an activated surface. This could be done, for example, by using a suitable heating device 95 such as an infrared device, which is moved along the spar cap member surface 63 as illustrated by the arrow in FIG. 6b. Preferably, the temperature applied to during the heating step is 90-120° C.

Then, as illustrated in FIGS. 6c and 6d, the spar cap member 62 is placed into the moulding cavity on top of at least part of a fibre layup such that at least part of said activated surface 63 of the spar cap member contacts the fibre layup 97. The fibre layup 97 has been prepared in a known way using a blade mould 96 with a moulding cavity 98 into which typically a number of fibre layers, such as glass fibre layers are placed, to form the shell part.

Next, the moulding cavity is infused with a resin. As illustrated in FIG. 6e, this can be done by placing a vacuum bag 99 on top of the fibre layup and the spar cap member, and then infusing resin from an inlet channel 100 in a VARTM process. The moulding cavity is preferably infused with a polyester resin, preferably with an unsaturated polyester resin.

Then, the resin is cured to form the hardened blade shell member. Preferably, the step of curing the resin to form the blade shell member comprises a free-radical crosslinking reaction between the silane compound and the unsaturated polyester resin, preferably between (meth)acrylate groups of the silane compound of the primer composition and the unsaturated polyester resin.

Now, according to the present invention, this method can be modified in that primer-treated composite articles, which later form the spar cap of the blade, can already be manufactured in a pultrusion process. FIG. 9 illustrates such pultrusion process for manufacturing the composite articles 64, such as pultrusion plates, of the present invention.

In the illustrated embodiment, the pultrusion process makes use of a pultrusion system 120 which comprises a portion for receiving a plurality of bobbins 102 each supplying a tow of fibre material such as carbon fibre material or glass fibre material from a creel 101. The tows 104 are pulled through guide plates 105, resin bath 106, and heated die 107 by pulling mechanism 108. The pultrusion string 109 is cut into individual pultrusion plates 64 by cutter 110. The shaped impregnated fibres are cured and can optionally be wound onto a roll. The guide plates and/or the die may take the form of a spreader or inlet comprising multiple apertures, each aperture receiving a respective carbon fibre tow or glass fibre two. The apertures can be spaced and they are located so as to guide the fibre tows to form a desired pattern of glass fibre tows and carbon fibre tows in the pultrusion plates 64.

The primer composition, preferably a liquid primer composition, can be applied to the at least partially cured pultrusion string exiting the heated die by using a spray gun 94 as illustrated in FIG. 9. However, other techniques can be used, such as application by a brush, or various other application techniques. Then, heat is applied to the primer-treated surface to provide an activated surface by using a suitable heating device 95 such as an infrared device. Preferably, the temperature applied to the pultrusion string during this additional heating step is 90-120° C.

FIG. 10 is a simplified side view illustration of a process of imprinting a three-dimensional structure onto a surface of the primer-treated pultrusion string according to one embodiment of the present invention. Here, two rotating rollers 113a, 113b each having a three-dimensional pattern 114 on their surface are used for transferring said pattern onto an upper surface 115 and onto a lower surface 116 of the pultrusion string 109, respectively. This may for example create a dotted surface on the pultrusion string. The rollers 113a, 113b could also be used to apply the primer to the pultrusion string 109. The pultrusion direction or movement 111 of the pultrusion string 109 is illustrated as well as the rotational direction of the rollers.

In the embodiment illustrated in FIG. 11, the step of imprinting a three-dimensional structure 112, such as a dotted surface, comprises impinging a plurality of particles 117, such as metal particles, onto the surfaces 115, 116 of the primer-treated pultrusion string 109. This could be done by using a shot peening chamber 118.

### Example 1

FIG. 7 is a chart showing critical energy release rates (GIC) measured under different conditions. The GIC is the value of the energy release rate G in a precracked specimen under plane-strain loading conditions, when the crack starts to grow. It is expressed in joules per square metre, J/m2, or N/m. FIG. 7 shows the GIC determined according to ISO/DIS 13586(en) for two joined blade components using the silane-containing primer of the present invention in combination with an unsaturated polyester resin, wherein the polyester cure cycle was 16 hours at 40° C. (column A), 4 days at room temperature (column B), 3 hours at 90° C. (column C), and without any primer (column D). It was surprisingly found that the GIC is around 5 times higher using the method of the present invention (columns A, B, C) as compared to the same curing with unsaturated polyester resin without using the silane-based primer (column D). It is thus seen that the method of the present invention relates in a bond with high resistance to unstable crack propagation.

### Example 2

The effect of humidity on a primed spar cap surface using the silane-based primer of the present invention was tested over time, wherein a surface which has been treated with the primer and subsequently heated for activating the surface is exposed to a relative humidity of 80% at room temperature. FIG. 8 illustrates the time in days on the x-axis, whereas the y-axis is GIC in N/m. As seen in FIG. 8, only a minimal effect on bonding strength between two wind turbine blade components is seen over time. This demonstrates a surprising stability of the primer-treated wind turbine blade component for an extended time period.

### Example 3: Manufacturing of the Primer Composition

A primer composition according to one embodiment of the present invention can be prepared by carrying out the following steps:
adding dibasic ester Rhodiasolv® RPDE (containing by weight 57-67% dimethyl glutarate, 18-28% dimethyl succinate, and 8-22% dimethyl adipate) and 1-methoxy-2-propanol into a clean mixing vessel to provide a 1:1 ratio of dibasic ester and 1-methoxy-2-propanol by weight,
adding distilled vinegar or a pre-blend of 7% wt acetic acid/93% wt to the mixing vessel while slowly stirring,
mixing for 5-10 minutes until a homogeneous mixture is achieved,
adding Silquest A174NT (gamma-methacryloxypropyltrimethoxy silane), while slowly stirring, into the mixing vessel.
stirring for 60 minutes.
dispensing the resulting primer composition into containers with subsequent sealing.

In the final primer the weight percentages are 46.2% for dibasic ester rhodiasolv® RPDE, 46.3% for 1-Methoxy-2-Propanol, 5% for the distilled vinegar (or the pre-blend of 7% wt acetic acid/93% wt), and 2.5% for the Silquest A174NT.

The invention is not limited to the embodiments described herein and may be modified or adapted without departing from the scope of the present invention.

### LIST OF REFERENCE NUMERALS

4 tower
6 nacelle
8 hub
10 blades
14 blade tip
16 blade root
18 leading edge
20 trailing edge
30 root region
32 transition region
34 airfoil region
36 pressure side shell part
38 suction side shell part
40 shoulder
41 spar cap
42 fibre layers
43 sandwich core material
45 spar cap
46 fibre layers
47 sandwich core material
50 first shear web
51 core member
52 skin layers
55 second shear web
56 sandwich core material of second shear web
57 skin layers of second shear web
60 filler ropes
61 top surface of spar cap
62 reinforcing structure/spar cap
63 bottom surface of spar cap
64 pultrusion plate
66 stack of pultrusion plates
74 tip end of reinforcing structure
76 root end of reinforcing structure
78 front edge of reinforcing structure
80 rear edge of reinforcing structure
81 top surface of pultrusion plate
82 bottom surface of pultrusion plate
83 first lateral surface of pultrusion plate
84 second lateral surface of pultrusion plate
85 organo alkoxysilane monomer
86 hydrolyzed organo alkoxysilane monomer
87 polymeric organo alkoxysilane
88 hydrogen bonds
89 covalent bonds
90 hydrolysis
91 condensation/polymerization
92 treatment of spar cap with primer composition
93 heating
94 spray gun
95 heating device
96 blade mould
97 fibre layup
98 moulding cavity
99 vacuum bag
100 resin inlet channel
101 creel
102 bobbins
104 tows
105 guide plates
106 resin bath
107 heated die
108 pulling mechanism
109 pultrusion string
110 cutter
111 direction of movement of pultrusion string
112 3D-structure on surface
113 roller
114 3D-pattern on roller
115 upper surface of pultrusion string
116 lower surface of pultrusion string
117 particles
118 shot peening chamber
120 pultrusion system
L length
r distance from hub
R rotor radius
Se spanwise extent of reinforcing structure

1. A pultrusion process for manufacturing a fibre reinforced composite article (64), wherein the pultrusion process comprises the steps of
impregnating a fibre material with a resin to form a resin-impregnated pultrusion string (109),
pulling the resin-impregnated pultrusion string through a die (107) and applying heat to the resin-impregnated pultrusion string (109) to form an at least partially cured pultrusion string,
treating a surface (115, 116) of the at least partially cured pultrusion string with a primer composition comprising a silane compound to form a primer-treated pultrusion string, and
cutting the primer-treated pultrusion string to provide the composite article (64).

2. A pultrusion process according to claim 1, wherein the silane compound comprises a hydroxysilylalkyl methacrylate or a (poly) condensation product of a hydroxysilylalkyl methacrylate.

3. A pultrusion process according to claim 1, wherein the silane compound is a polymer comprising a repeating unit of formula (I): 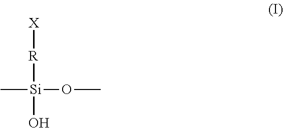
wherein X is an organic group, preferably a non-hydrolyzable organic group, preferably selected from amino, vinyl, epoxy, (meth)acrylate, sulfur, alkyl, alkenyl, alkynyl, most preferably methacrylate, and wherein R is a spacer such as —(CH₂)ₙ—, wherein n is 0 to 1000, preferably 1-5, most preferably 3.

4. A pultrusion process according to claim 1, wherein the resin is a vinyl ester resin.

5. A pultrusion process according to claim 1, wherein the die (107) is a heated die, and wherein the step of applying heat to the resin-impregnated pultrusion string is carried out while pulling the resin-impregnated pultrusion string through the heated die.

6. A pultrusion process according to claim 1, wherein the process further comprises applying heat to the primer-treated pultrusion string, or to the composite article, to provide an activated surface, preferably wherein the heating temperature is 80-130° C., most preferably 90-120° C.

7. A pultrusion process according to claim 1, wherein the process further comprises a step of imprinting a three-dimensional structure (112) onto a surface (115, 116) of the primer-treated pultrusion string.

8. A pultrusion process according to claim 7, wherein the step of imprinting a three-dimensional structure comprises impinging a plurality of particles (117), preferably metal particles, onto the surface of the primer-treated pultrusion string, preferably by shot peening.

9. A pultrusion process according to claim 7, wherein the step of treating the surface of the at least partially cured pultrusion string with a primer composition is carried out using at least one roller (113) having a three-dimensional pattern (114) on its surface for transferring said pattern onto a surface of the pultrusion string.

10. A pultrusion process according to claim 9, wherein the pattern is an undulated pattern.

11. A pultrusion process according to claim 9, wherein the pattern comprises a plurality of dots.

12. A pultruded composite article (64), such as a pultrusion plate, obtainable by the pultrusion process of claim 1.

13. A pultruded composite article according to claim 12, wherein the layer thickness of the primer composition is 10-50 μm.

14. A pultruded composite article according to claim 12, wherein the surface of the composite article comprises a three-dimensional pattern, preferably a dotted pattern.

15. A method of manufacturing a wind turbine blade shell member (36, 38), the method comprising the steps of
providing a blade mould (96) for the blade shell member, the blade mould comprising a moulding cavity (98),
arranging one or more layers of fibre material in the moulding cavity to provide a fibre layup (97),
placing a plurality of pultruded composite articles obtained by the pultrusion process of claim 1 into the moulding cavity on top of at least part of the fibre layup (97),
infusing the moulding cavity with resin, and
curing the resin to form the blade shell member.
